(19) United States
(12) Patent Application Publication
(10) Pub. No.: US 2023/0237317 A1
(43) Pub. Date: Jul. 27, 2023

(54) EARLY DETERMINATION TRAINING ACCELERATOR BASED ON TIMESTEP SPLITTING OF SPIKING NEURAL NETWORK AND OPERATION METHOD THEREOF

(71) Applicant: Korea University Research and Business Foundation, Seoul (KR)

(72) Inventors: Jongsun PARK, Seoul (KR); Sung Hyun CHOI, Seoul (KR); Dongwoo LEW, Seoul (KR)

(73) Assignee: Korea University Research and Business Foundation, Seoul (KR)

(21) Appl. No.: 18/099,560

(22) Filed: Jan. 20, 2023

(30) Foreign Application Priority Data
Jan. 24, 2022 (KR) 10-2022-0009753
Mar. 14, 2022 (KR) 10-2022-0031156

(51) Int. Cl. G06N 3/049; G06V 10/774

(52) U.S. Cl. CPC G06N 3/049; G06V 10/774

(57) ABSTRACT

Disclosed are a method for accelerating early determination training. The method for accelerating early determination training includes a timestep splitting operation of splitting a timestep, a membrane potential measuring operation of measuring first and second membrane potentials for each splitted timestep during a current training process, a threshold value calculation operation of calculating a threshold value to be used in a subsequent training process based on the first and second membrane potentials, and when a difference between the first and second membrane potentials in the splitted timestep is greater than the threshold value, an early training termination operation of determining that the image does not have the training contribution and terminating training at the splitted timestep.

### CROSS REFERENCE TO RELATED APPLICATIONS

This application claims priority under 35 U.S.C. § 119 to Korean Patent Applications 10-2022-0031156 filed on Mar. 14, 2022 and No. 10-2022-0009753 filed on Jan. 24, 2022, in the Korean Intellectual Property Office, the disclosures of which are incorporated by reference herein in their entireties.

### BACKGROUND

Embodiments of the present disclosure relate to an early determination training accelerator based on the timestep splitting of a spiking neural network and an operation method thereof.

Spiking neural networks receive and transfer information in spike units of ‘0’ and ‘1’, so they have the advantage of low power consumption in hardware implementation. In addition, as the number of spikes in an inference process decreases with the introduction of temporal coding, the energy of the inference process is greatly reduced. However, training in the neural networks has issues in that energy consumption and training time are very large as the training process including inference, backpropagation, and weight update is repeated with respect to a very large number of training images.

### SUMMARY

Embodiments of the present disclosure provide an apparatus and a method for accelerating an early determination training based on the timestep splitting that can reduce training energy and training time by splitting a timestep, determining the network contribution of a training image, and early terminating training of images having no the training contribution.

According to an embodiment of the present disclosure, a method of accelerating early determination training includes a timestep splitting operation of splitting a timestep, a membrane potential measuring operation of measuring first and second membrane potentials for each splitted timestep during a current training process, a threshold value calculation operation of calculating a threshold value to be used in a subsequent training process based on the first and second membrane potentials, and when a difference between the first and second membrane potentials in the splitted timestep is greater than the threshold value, an early training termination operation of determining that the image does not have the training contribution and terminating training at the splitted timestep.

According to an embodiment, the first membrane potential may be a membrane potential of a correct answer neuron, and the second membrane potential may be a largest membrane potential among membrane potentials excluding membrane potentials of the correct answer neuron among a plurality of membrane potentials.

According to an embodiment, the threshold value calculation operation may calculate the threshold value based on Equation 1, Equation 1 may be a=m+2σ, and where, ‘a’ may be the threshold value, ‘m’ may be an average of a membrane potential difference distribution of images with the training contribution, and ‘σ’ may be a deviation of the membrane potential difference distribution of the images with the training contribution.

According to an embodiment, the training early termination operation may set a boundary between the image having no the training contribution and the image having the training contribution based on Equation 2, Equation 2 may be y=x-a, and where, ‘a’ may be the threshold value calculated in the previous training process, ‘x’ may be the membrane potential of the correct answer neuron, and ‘y’ may be the largest membrane potential among membrane potentials excluding membrane potentials of the correct answer neuron among the plurality of membrane potentials.

According to an embodiment, the training early termination operation may determine images having no the training contribution based on Equation 3 modified from Equation 2, Equation 3 may be x-y≥a, and where, ‘a’ may be the threshold value calculated in the previous training process, ‘x’ may be the membrane potential of the correct answer neuron, and ‘y’ may be the largest membrane potential among membrane potentials excluding membrane potentials of the correct answer neuron among the plurality of membrane potentials.

According to an embodiment, when Equation 3 is satisfied by substituting the first and second membrane potentials and the threshold value for each timestep into Equation 3, the training early termination operation may determine that the image has no the training contribution and may terminate the training at the splitted timestep, and, when Equation 3 is not satisfied by substituting the first and second membrane potentials and the threshold value for the each splitted timestep into Equation 3, the training early termination operation may determine that the image has the training contribution and may proceed with training.

According to an embodiment, the splitted timestep may be a timestep in which one timestep is splitted into one of 2 to 16.

According to an embodiment of the present disclosure, an early determination training accelerator based on a timestep splitting includes an input layer module into which an input spike signal of the spiking neural network is input, a hidden layer module that receives the input spike signal, an output layer module that receives the input spike signal from the hidden layer module, determines an image having no training contribution, and calculates a threshold value for determining presence or absence of the training contribution, and a global controller that terminates a training process based on the presence or absence of the training contribution determined by the output layer module.

According to an embodiment, the hidden layer module may include a membrane potential update module that receives the input spike signal from the input layer module and calculates membrane potentials of a plurality of neurons based on input spikes, a weight update module that adds weights of the input spikes to the membrane potential based on an input of the input spike signal, a membrane potential buffer that stores the membrane potentials of the plurality of neurons, and a spike time buffer that stores spike occurrence times of the plurality of neurons.

According to an embodiment, the output layer module may include a spike buffer that receives the input spike signal from the hidden layer module, a membrane potential update module that receives the input spike signal from the spike buffer and calculates membrane potentials of a plurality of neurons based on input spikes, a weight update module that adds weights of the input spikes to the membrane potential based on an input of the input spike signal, a membrane potential buffer that stores the membrane potentials of the plurality of neurons, a spike time buffer that stores spike occurrence times of the plurality of neurons, an error calculation unit that calculates a difference between a spike occurrence time of the plurality of neurons after a forward propagation process is finished during a training process and a target correct answer signal, an early determination unit that determines an image having no the training contribution when calculation of each timestep in the forward propagation process is completed, and a threshold calculation unit that calculates a threshold value to be used in a subsequent training after the forward propagation process is completed.

According to an embodiment, when a difference between the first and second membrane potentials in the timestep is greater than the threshold value, the early determination unit may determine that the image does not have the training contribution and may terminate the training at the timestep.

According to an embodiment, the threshold value calculation unit may calculate the threshold value to be used in a subsequent training process based on distribution data of first and second membrane potentials among the membrane potentials of the plurality of neurons.

According to an embodiment, the first membrane potential may be a membrane potential of a correct answer neuron, and the second membrane potential may be a largest membrane potential among membrane potentials excluding membrane potentials of the correct answer neuron among a plurality of membrane potentials.

### BRIEF DESCRIPTION OF THE FIGURES

The above and other objects and features of the present disclosure will become apparent by describing in detail embodiments thereof with reference to the accompanying drawings.

FIG. 1 is a graph illustrating a ratio of images having no training contribution according to a training process.

FIG. 2 is a flowchart illustrating a method for accelerating an early determination training based on a timestep splitting, according to an embodiment of the present disclosure.

FIG. 3 is a diagram illustrating a timestep splitting operation, according to an embodiment of the present disclosure.

FIG. 4 is a diagram illustrating a method of calculating a threshold value, according to an embodiment of the present disclosure.

FIG. 5 is a diagram illustrating a method of early terminating training by determining an image having no training contribution, according to an embodiment of the present disclosure.

FIG. 6 is a diagram illustrating an example of early termination training with respect to a splitted timestep, according to an embodiment of the present disclosure.

FIG. 7 is a diagram illustrating an early determination training accelerator based on a timestep splitting, according to an embodiment of the present disclosure.

### DETAILED DESCRIPTION

Hereinafter, embodiments of the present disclosure will be described with reference to the accompanying drawings so as to describe the technical idea of the present disclosure in detail to such an extent that those skilled in the art can easily implement the present disclosure.

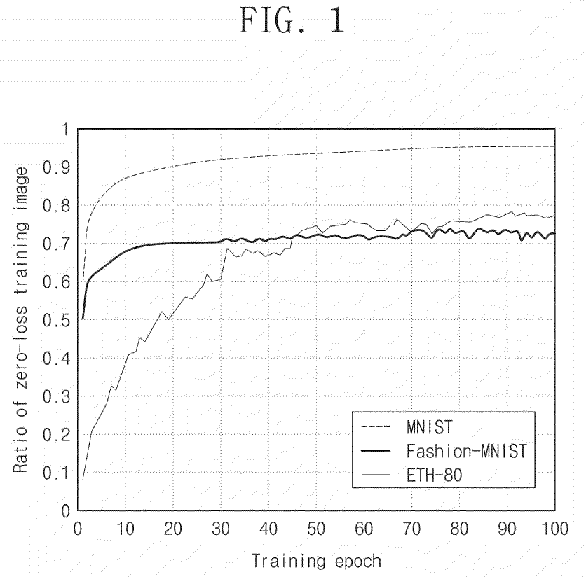

FIG. 1 is a graph illustrating a ratio of images with no training contribution according to a training process.

Referring to FIG. 1, it is possible to measure a ratio of images having no training contribution according to the training process using a plurality of datasets. In this case, an x-axis may represent a training process, and a y-axis may represent a ratio of images that do not contribute to training among training data for each of a plurality of datasets. The plurality of datasets may be one of MNIST, Fashion-MNIST, and ETH-80.

In the case of the MNIST dataset, when the size of the training set is 60000 and the ratio of images having no the training contribution according to the training process is 0.5, there may be 30000 images having no the training contribution.

In the case of the Fashion-MNIST dataset, when the size of the training set is 60000 and the ratio of images having no the training contribution according to the training process is 0.5, there may be 30000 images having no the training contribution.

In the case of the ETH-80 dataset, there are a total of 3280 images. For example, 2624 images, which are 80% of the total images may be used as a training set, and 656 images, which are 20% of the total images may be used as an inference set.

As described above, it can be seen that in the training process of the spiking neural network based on the conventional technology, the ratio of images having no the training contribution is large, and the number of images having no the training contribution further increases as training progresses. As such, when the number of images having no the training contribution increases during the training process, there is a problem in that energy consumption increases and computation time takes a long time.

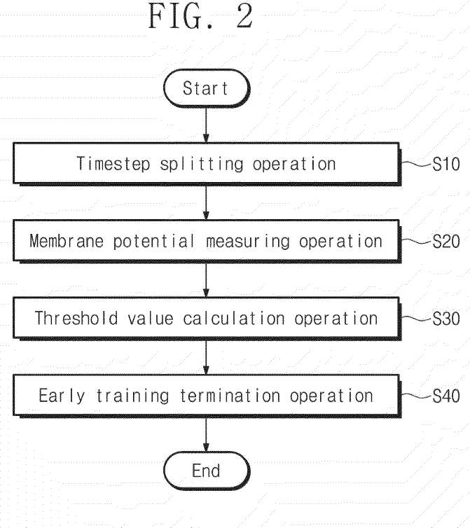

FIG. 2 is a flowchart illustrating a method for accelerating an early determination training based on a timestep splitting, according to an embodiment of the present disclosure.

In operation S10, an early determination training accelerator based on a timestep splitting may split a timestep. For example, the early determination training accelerator based on a timestep splitting may split one timestep into one of 2 to 16.

In operation S20, an early determination training accelerator based on the timestep splitting may measure a membrane potential. For example, the early determination training accelerator based on the timestep splitting may measure first and second membrane potentials for each splitted timestep during a current training process.

In this case, the first membrane potential may be a membrane potential of a correct answer neuron, and the second membrane potential may be a largest membrane potential among membrane potentials excluding membrane potentials of the correct answer neuron among a plurality of membrane potentials.

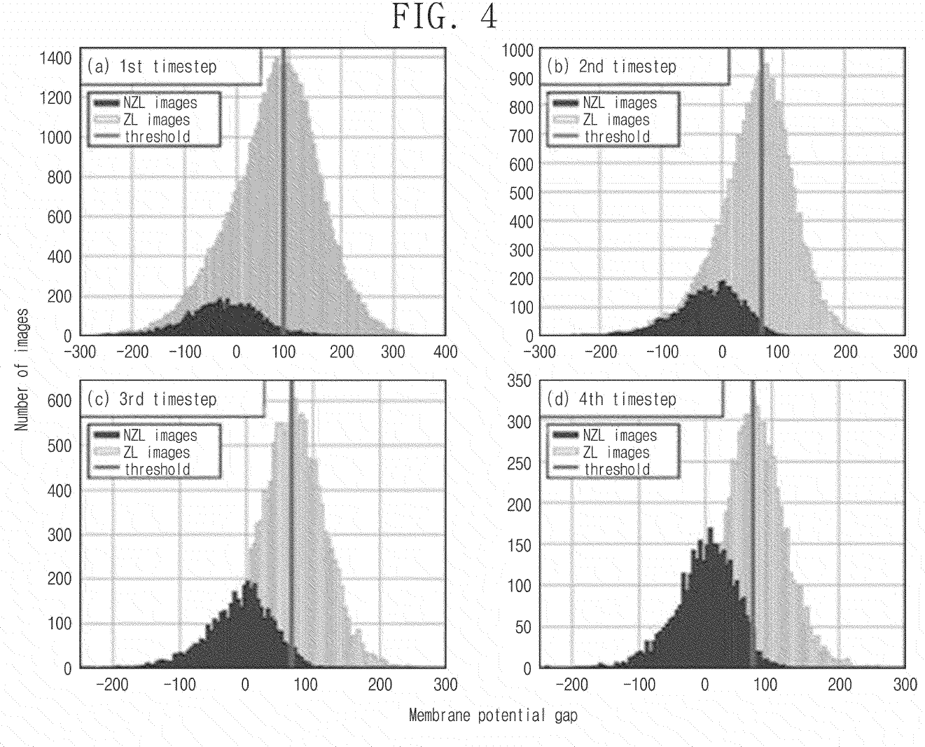

In operation S30, an early determination training accelerator based on the timestep splitting may calculate a threshold value. For example, the early determination training accelerator based on the timestep splitting may calculate a threshold value to be used in a subsequent training process based on the distribution data of current first and second membrane potentials. In this case, the threshold value may be calculated based on Equation 1, and details regarding this will be described later with reference to FIG. 4.

In operation S40, when a difference between the first and second membrane potentials in the splitted timestep is greater than the threshold value, the early determination training accelerator based on the timestep splitting may determine that the image does not have the training contribution and may terminate the training at the splitted timestep. Accordingly, the early determination training accelerator based on the timestep splitting may reduce the amount of computation and computation time without reducing accuracy by terminating training with respect to images that do not contribute to training.

In more detail, the early determination training accelerator based on the timestep splitting splits one timestep to terminate training with respect to images having no the training contribution, thereby reducing the amount of computation and computation time compared to terminating training with respect to images having no the training contribution in one timestep.

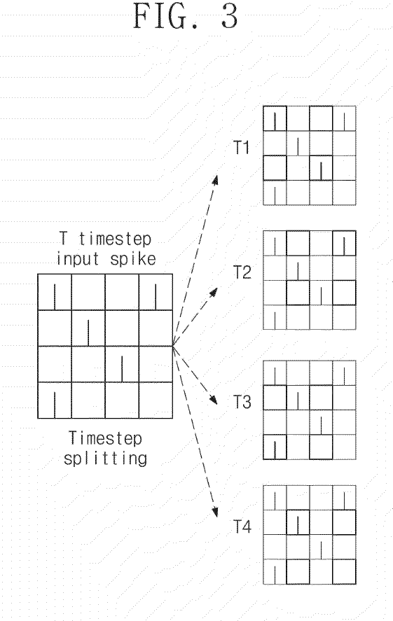

FIG. 3 is a diagram illustrating a timestep splitting operation, according to an embodiment of the present disclosure.

Referring to FIG. 3, one timestep includes 16 cells, and at least one of the 16 cells may have an input spike. For example, as illustrated in FIG. 3, one timestep may include the 1st to 16th cells, and the 1st, 4th, 6th, 11th, and 13th cells may have the input spike, respectively.

The early determination training accelerator based on the timestep splitting may split one timestep into four timesteps.

In this case, the first splitting area may include the 1st, 3rd, 9th, and 11th cells, the second splitting area may include the 2nd, 4th, 10th, and 12th cells, and the third splitting area may include the 5th, 7th, 13th, and 15th cells, and the fourth splitting area may include the 6th, 8th, 14th, and 16th cells.

However, the above description is only an example, and the timesteps may be splitted into 2 to 16 timesteps.

For example, when a timestep is splitted into two timesteps, the first splitting area may include 1st to 8th cells, and the second splitting area may include 9th to 16th cells.

As another example, when the timestep is splitted into two timesteps, the first splitting area may include the 1st, 3rd, 5th, 7th, 9th, 11th, 13th, and 15th cells, and the second splitting area may include the 2nd, 4th, 6th, 8th, 10th, 12th, 14th, and 16th cells.

FIG. 4 is a diagram illustrating a method of calculating a threshold value, according to an embodiment of the present disclosure.

Referring to FIG. 4, the early determination training accelerator based on the timestep splitting may represent images (NZL images) having the training contribution and images (ZL images) having no the training contribution in Gaussian form during the training process.

For example, the early determination training accelerator based on the timestep splitting may represent images (NZL images) having the training contribution and images (ZL images) having no the training contribution in the Gaussian form in which the x-axis is a gap of the membrane potential and the y-axis is the number of images having the corresponding membrane potential gap.

The early determination training accelerator based on the timestep splitting may calculate the threshold value based on data expressed in the Gaussian form, that is, based on the membrane potential gap and the number of images having the corresponding membrane potential gap according to a timestep. In this case, the membrane potential gap may be a difference between the membrane potential of the correct neuron and the maximum membrane potential of the membrane potentials of the remaining neurons.

The threshold value may be calculated based on Equation 1. Equation 1 is as follows. [0052]

$$a = m + 2 \text{σ}$$

In this case, ‘a’ may be the threshold value, ‘m’ may be an average of a membrane potential difference distribution of images with the training contribution, and ‘σ’ may be a deviation of the membrane potential difference distribution of the images with the training contribution.

As the threshold value is calculated for each timestep and training process without being found empirically, it may be automatically calculated regardless of a data net and network.

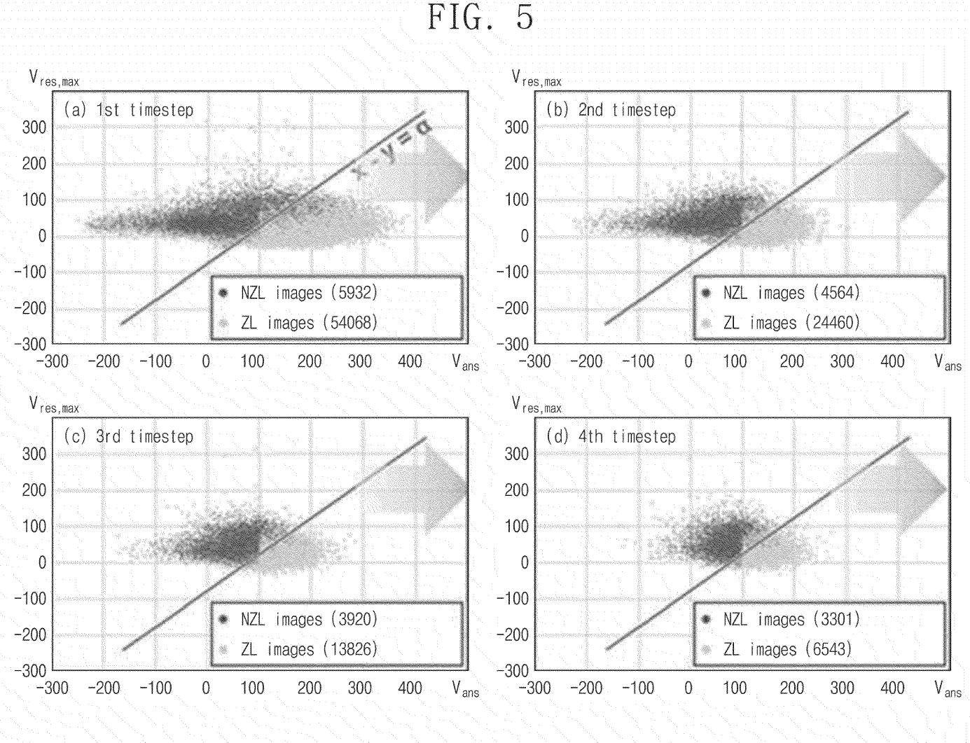

FIG. 5 is a diagram illustrating a method of early terminating training by determining an image having no training contribution, according to an embodiment of the present disclosure.

Referring to FIG. 5, the early determination training accelerator based on the timestep splitting may represent the distribution of images having no the training contribution and the distribution of images having the training contribution in the form of a scatter plot in which the x-axis is the membrane potential (Vans) of the correct neuron and the y-axis is the membrane potential (Vres, max) of the maximum value among the membrane potentials of neurons excluding the correct neuron.

The early determination training accelerator based on the timestep splitting may determine a relationship between the first and second membrane potentials in training images for the number of times of one training in the training process according to the timestep, based on the data represented in the form of the scatter plot.

The early determination training accelerator based on the timestep splitting may set a boundary between an image having no the training contribution and an image having the training contribution based on Equation 2.

Equation 2 may be y=x-a.

Here, ‘a’ may be the threshold value calculated in the previous training process, ‘x’ may be a first membrane potential which is the membrane potential of the correct answer neuron, and ‘y’ may be a second membrane potential which is the largest membrane potential among membrane potentials excluding membrane potentials of the correct answer neuron among the plurality of membrane potentials.

The early determination training accelerator based on the timestep splitting may terminate training with respect to an image having no the training contribution based on Equation 3 generated by modifying Equation 2.

Equation 3 may be x-y≥a.

In this case, ‘a’ may be the threshold value calculated in the previous training process, ‘x’ may be the first membrane potential which is the membrane potential of the correct answer neuron, and ‘y’ may be the second membrane potential which is the largest membrane potential among membrane potentials excluding membrane potentials of the correct answer neuron among the plurality of membrane potentials.

When Equation 3 is satisfied, the early determination training accelerator based on the timestep splitting may determine that the image has no the training contribution and may terminate the ongoing training. In contrast, when Equation 3 is not satisfied, the early determination training accelerator based on the timestep splitting may determine that the image has the training contribution and may proceed with training.

In detail, when a difference between the first membrane potential and the second membrane potential is greater than the threshold value (the right side of a line), the early determination training accelerator based on the timestep splitting may determine that the image has no the training contribution and may terminate training.

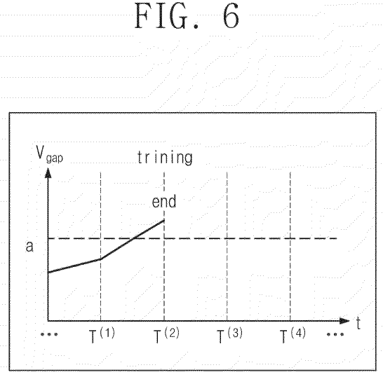

FIG. 6 is a diagram illustrating an example of early termination training with respect to a splitted timestep, according to an embodiment of the present disclosure.

Referring to FIG. 6, the early determination training accelerator based on the timestep splitting may terminate training at the splitted timestep when a difference (Vgap) between the first and second membrane potentials is greater than or equal to a threshold value in the corresponding splitted timestep.

For example, when one timestep is splitted into first to fourth timesteps T1, T2, T3, and T4, and the difference (Vgap) between the first and second membrane potentials between the first and second timesteps T1 and T2 is equal to or greater than the threshold value, the early determination training accelerator based on the timestep splitting may terminate the training at the second timestep T2.

As described above, the early determination training accelerator based on the timestep splitting does not terminate training with respect to the entirety of one timestep, but may terminate in the middle of one timestep based on the first and second membrane potential difference (Vgap) and a threshold value (a). Accordingly, it is possible to reduce the computation amount and computation time in the training.

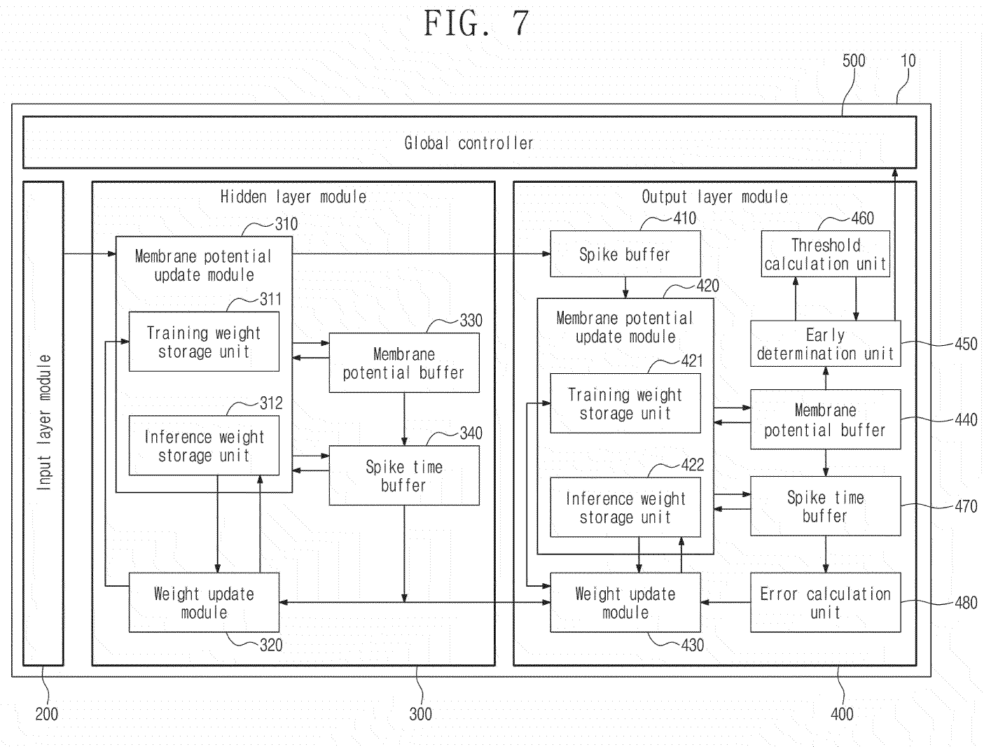

FIG. 7 is a diagram illustrating an early determination training accelerator based on a timestep splitting, according to an embodiment of the present disclosure.

Referring to FIG. 7, the early determination training accelerator 10 based on the timestep splitting may include an input layer module 200, a hidden layer module 300, an output layer module 400, and a global controller 500.

The input layer module 200 may receive an input spike signal of a spiking neural network.

The hidden layer module 300 may receive the input spike signal from the input layer module 200. In this case, the hidden layer module 300 may include a membrane potential update module 310, a weight update module 320, a membrane potential buffer 330, and a spike time buffer 340.

The membrane potential update module 310 may receive the input spike signal from the input layer module 200 and may calculate membrane potentials of a plurality of neurons based on input spikes.

The membrane potential update module 310 may include a training weight storage unit 311 and an inference weight storage unit 312.

The training weight storage unit 311 may update the membrane potential by receiving weights from the weight update module 320 during the training process.

The inference weight storage unit 312 may update the membrane potential by receiving weights from the weight update module 320 during the inference process.

The weight update module 320 may add weights of the input spikes to the membrane potential based on the input of the input spike signal. The weight update module 320 may transmit weight information to the training weight storage unit 311 and the inference weight storage unit 312. Also, the weight update module 320 may transmit the weight information to a weight update module 430 of the output layer module 400.

The membrane potential buffer 330 may store membrane potentials of a plurality of neurons. The membrane potential buffer may transmit or receive a membrane potential value to/from the membrane potential update module 310. Also, the membrane potential buffer 330 may transmit information about the membrane potential to the spike time buffer 340.

The spike time buffer 340 may store spike occurrence times of the plurality of neurons.

The output layer module 400 may receive an input spike signal from the hidden layer module 300, may determine images having no the training contribution, and may calculate a threshold for determining whether the image has the training contribution. In this case, the output layer module 400 may include a spike buffer 410, a membrane potential update module 420, the weight update module 430, a membrane potential buffer 440, an early determination unit 450, a threshold calculation unit 460, a spike time buffer 470, and an error calculation unit 480.

The spike buffer 410 may receive an input spike signal from the membrane potential update module of the hidden layer module 300. The spike buffer 410 may transmit the input spike signal to the membrane potential update module 420.

The membrane potential update module 420 may receive the input spike signal from the input layer module 300 and may calculate membrane potentials of a plurality of neurons based on input spikes.

The membrane potential update module 420 may include a training weight storage unit 421 and an inference weight storage unit 422.

The training weight storage unit 421 may update the membrane potential by receiving weights from the weight update module 430 during the training process.

The inference weight storage unit 422 may update the membrane potential by receiving weights from the weight update module 430 during the inference process.

The weight update module 430 may add weights of the input spikes to the membrane potential based on the input of the input spike signal. The weight update module 430 may transmit weight information to the training weight storage unit 421 and the inference weight storage unit 422. Also, the weight update module 430 may transmit the weight information to the weight update module 320 of the hidden layer module 300.

The membrane potential buffer 440 may store membrane potentials of a plurality of neurons. The membrane potential buffer 440 may transmit or receive a membrane potential value to/from the membrane potential update module 420. In addition, the membrane potential buffer 440 may transmit information about the membrane potential to the spike time buffer 470 and the early determination unit 450.

The early determination unit 450 may determine an image having no the training contribution when calculation of each timestep is completed in the forward propagation process. The early determination unit 450 may transmit the determination result to the global controller 500.

For example, when a difference between the first and second membrane potentials in the timestep is greater than the threshold value, the early determination unit 450 may determine that the image does not have the training contribution and may terminate the training at the timestep. In this case, the first membrane potential may be a membrane potential of a correct answer neuron, and the second membrane potential may be the largest membrane potential among membrane potentials excluding membrane potentials of the correct answer neuron among a plurality of membrane potentials.

The threshold calculator 460 may calculate a threshold to be used in the subsequent training after the forward propagation process is finished. In addition, the threshold calculation unit 460 may transmit the threshold value calculated in the previous training to the early determination unit 450.

The spike time buffer 470 may store spike occurrence times of the plurality of neurons. The spike time buffer 470 may transmit the spike occurrence time to the error calculation unit 480.

The error calculation unit 480 may calculate whether there is an error by calculating a difference between the spike occurrence time of the plurality of neurons after the forward propagation process is finished and the target correct answer signal. The error calculation unit may transmit the calculation result to the weight update module 430.

The global controller 500 may terminate the training process based on whether or not there is the training contribution determined by the early determination unit 450 of the output layer module 400. For example, when the early determination unit 450 determines that the image has no the training contribution, the global controller 500 may terminate the training process.

According to an embodiment of the present disclosure, the apparatus and the method for accelerating the early determination training based on a timestep splitting may reduce training energy and training time by splitting the timestep, determining the network contribution of a training image, and by early terminating image training having no the training contribution.

The embodiments disclosed in this specification and drawings are only presented as specific examples to easily describe the content of the present disclosure and help understanding, and are not intended to limit the scope of the present disclosure. Accordingly, the scope of the present disclosure should be construed as including all changes or modified forms derived based on the technical spirit of the present disclosure in addition to the embodiments disclosed herein.

What is claimed is:

1. A method of accelerating early determination training based on a timestep splitting, the method comprising:
a timestep splitting operation of splitting a timestep;
a membrane potential measuring operation of measuring first and second membrane potentials for each splitted timestep during a current training process;
a threshold value calculation operation of calculating a threshold value to be used in a subsequent training process based on the first and second membrane potentials; and
when a difference between the first and second membrane potentials in the splitted timestep is greater than the threshold value, an early training termination operation of determining that the image does not have the training contribution and terminating training at the splitted timestep.

2. The method of claim 1, wherein the first membrane potential is a membrane potential of a correct answer neuron, and the second membrane potential is a largest membrane potential among membrane potentials excluding membrane potentials of the correct answer neuron among a plurality of membrane potentials.

3. The method of claim 2, wherein the threshold value calculation operation calculates the threshold value based on Equation 1, Equation 1 is a=m+2σ, and where, ‘a’ is the threshold value, ‘m’ is an average of a membrane potential difference distribution of images with the training contribution, and ‘σ’ is a deviation of a membrane potential difference distribution of the images with the training contribution.

4. The method of claim 2, wherein the training early termination operation sets a boundary between the image having no the training contribution and the image having the training contribution based on Equation 2, Equation 2 is y=x-a, and where, ‘a’ is the threshold value calculated in the previous training process, ‘x’ is the membrane potential of the correct answer neuron, and ‘y’ is the largest membrane potential among membrane potentials excluding membrane potentials of the correct answer neuron among the plurality of membrane potentials.

5. The method of claim 4, wherein the training early termination operation determines images having no the training contribution based on Equation 3 modified from Equation 2, Equation 3 is x-y≥a, and where, ‘a’ is the threshold value calculated in the previous training process, ‘x’ is the membrane potential of the correct answer neuron, and ‘y’ is the largest membrane potential among membrane potentials excluding the membrane potentials of the correct answer neuron among the plurality of membrane potentials.

6. The method of claim 5, wherein, when Equation 3 is satisfied by substituting the first and second membrane potentials and the threshold value for the each splitted timestep into Equation 3, the training early termination operation determines that the image has no the training contribution and terminates the training at the splitted timestep, and
wherein, when Equation 3 is not satisfied by substituting the first and second membrane potentials and the threshold value for the each splitted timestep into Equation 3, the training early termination operation determines that the image has the training contribution and proceeds with training.

7. The method of claim 1, wherein the splitted timestep is a timestep in which one timestep is splitted into one of 2 to 16.

8. An early determination training accelerator based on a timestep splitting comprising:
an input layer module into which an input spike signal of a spiking neural network is input;
a hidden layer module configured to receive the input spike signal;
an output layer module configured to receive the input spike signal from the hidden layer module, to determine an image having no training contribution, and to calculate a threshold value for determining presence or absence of the training contribution; and
a global controller configured to terminate a training process based on the presence or absence of the training contribution determined by the output layer module.

9. The early determination training accelerator based on the timestep splitting of claim 8, wherein the hidden layer module includes:
a membrane potential update module configured to receive the input spike signal from the input layer module and to calculate membrane potentials of a plurality of neurons based on input spikes;
a weight update module configured to add weights of the input spikes to the membrane potential based on an input of the input spike signal;
a membrane potential buffer configured to store the membrane potentials of the plurality of neurons; and
a spike time buffer configured to store spike occurrence times of the plurality of neurons.

10. The early determination training accelerator based on the timestep splitting of claim 8, wherein the output layer module includes:
a spike buffer configured to receive the input spike signal from the hidden layer module;
a membrane potential update module configured to receive the input spike signal from the spike buffer and to calculate membrane potentials of a plurality of neurons based on input spikes;
a weight update module configured to add weights of the input spikes to the membrane potential based on an input of the input spike signal;
a membrane potential buffer configured to store the membrane potentials of the plurality of neurons; and
a spike time buffer configured to store spike occurrence times of the plurality of neurons;
an error calculation unit configured to calculate a difference between a spike occurrence time of the plurality of neurons after a forward propagation process is finished during a training process and a target correct answer signal;
an early determination unit configured to determine an image having no the training contribution when calculation of each timestep in the forward propagation process is completed; and
a threshold calculation unit configured to calculate a threshold value to be used in a subsequent training after the forward propagation process is completed.

11. The early determination training accelerator based on the timestep splitting of claim 10, wherein, when a difference between the first and second membrane potentials in the timestep is greater than the threshold value, the early determination unit determines that the image does not have the training contribution and terminates the training at the timestep.

12. The early determination training accelerator based on the timestep splitting of claim 10, wherein the threshold value calculation unit calculates the threshold value to be used in a subsequent training process based on distribution data of first and second membrane potentials among the membrane potentials of the plurality of neurons.

13. The early determination training accelerator based on the timestep splitting of claim 12, wherein the first membrane potential is a membrane potential of a correct answer neuron, and the second membrane potential is a largest membrane potential among membrane potentials excluding membrane potentials of the correct answer neuron among a plurality of membrane potentials.
